(19) United States
(12) Patent Application Publication
(10) Pub. No.: US 2016/0314763 A1
(43) Pub. Date: Oct. 27, 2016

(54) METHOD AND APPARATUS FOR IMPROVING USER INTERFACE VISIBILITY IN AGRICULTURAL MACHINES

(71) Applicant: AGCO CORPORATION, Hesston, KS (US)

(72) Inventor: Paul Ross Matthews, Dietmannsried (DE)

(21) Appl. No.: 15/103,219

(22) PCT Filed: Dec. 9, 2014
(86) PCT No.: PCT/US2014/069226

§ 371 Date: Jun. 9, 2016

Related U.S. Application Data
(60) Provisional application No. 61/913,647, filed on Dec. 9, 2013.

(51) Int. Cl. G09G 5/10; G09G 5/06

(52) U.S. Cl. CPC G09G 5/10; G09G 5/06; G09G 2320/066; G09G 2354/00; G09G 2360/144; G09G 2320/0626

(57) ABSTRACT

Systems and methods for automatically and dynamically improving user interface visibility in response to environmental conditions are presented. In an example embodiment, a display device can be configured to operate in a variety of modes differentiated by display parameters and characteristics. Designation of a particular operational mode can be dependent on a number of factors, including whether an operator is looking at the screen or not. A display control unit (DCU) can be configured to receive sensor and geoposition data and use the data to designate an operational mode for a display device. A glare mitigation mode can be implemented to improve visibility under glare conditions, and an enhanced visibility mode can be implemented to improve visibility under low-light conditions. Other modes can include a normal operation mode and a resource conservation mode.

### BACKGROUND OF THE INVENTION

1. Field of Invention

This invention relates generally to user interface displays in agricultural vehicles, and more particularly to displays configured to dynamically adjust display characteristics to improve visibility.

2. Description of Related Art

Most contemporary agricultural machine operator cabins are equipped with display device that provides a user interface screen designed to provide timely information to an operator, such as guidance information, machine operating characteristics, machine implement status, work assignment progress, field data, and the like. As technology advances and machine operation becomes more automated, more data can be provided and updated faster in more sophisticated and aesthetically pleasing display designs. For example, a display screen can be designed to include graphics, icons and variably formatted text using a vast array of colors depicted with advanced color distribution techniques. In addition, a display device can be designed to allow an operator to adjust various user interface screen characteristics in accordance with operator needs and preferences, for example through navigation of various user preference menus.

Environmental conditions internal or external to a vehicle can cause visibility problems, making even the most sophisticated displays inside the vehicle difficult to read or somewhat uncomfortable to view. For example, a display screen can be subject to various types of glare due to natural or artificial light from distant sources. Display devices disposed in agricultural vehicles are especially susceptible to veiling glare caused by sunlight since the vehicles may be operated outdoors at all hours for extended periods of time. Glare caused by sunlight can worsen when a vehicle is headed in one direction and improve when the vehicle reverses direction. While an operator may be able to manually control some aspect or feature of a display, such as brightness, to improve display visibility, he may not have the desire to navigate through a series of menus each time he turns and heads in a different direction. Succumbing to the frustration that can result from staring at a screen that he cannot read, or frequently having to manually alter display parameters, he may choose to ignore or neglect the display screen when it is subject to under glare conditions. As a result he may not be able to confirm that the vehicle and its equipment are operating normally.

Visibility concerns can also be associated with darkened conditions. Agricultural machinery is often operated throughout all hours of the night. While there may be external lights in the proximity of the vehicle, in most cases the only light source in a vehicle cab is the display itself, which can be a bright distraction in an otherwise darkened cabin. A bright display in the midst of darkness can cause operator eye strain, and may make reading the screen more difficult. In addition to impairing visibility, a bright screen updated at high refresh rates can be an inefficient use of resources during the periods the operator is not looking at the screen. However, requiring an operator to manually alter the display characteristics can result in the same operator frustration experienced by daytime operators.

### OVERVIEW OF THE INVENTION

A system, apparatus and method for automatically and dynamically improving display screen visibility are presented. An example system can include a display device configured to provide a user interface screen, one or more sensors, and a display controller configured to receive data from the sensors, operate the display device and implement methods of the invention. In an example embodiment, the display controller can be configured to designate and effect a particular display operational mode based on whether an operator is looking at the display screen or not. For example, during nighttime conditions, a display device can operate in a resource conservation mode in which screen brightness, display information, and data refresh rates are reduced to conserve resources. However, the display device can be configured to automatically adjust user interface screen characteristics to transition to an enhanced visibility mode with improved visibility and readability when an operator looks at the screen. When the operator turns away from the screen, the display can return to the resource conservation mode. During daytime conditions, a system can be configured to designate a glare mitigation mode for a display screen in which display characteristics are selected to improve visibility for a display screen subject to glare. A system can be configured to implement a glare mitigation mode when the angle between sun and the display screen is within a predetermined range of angles at which veiling glare is likely to interfere with an operator's ability to see and read a user interface screen. In an example embodiment, a display device can operate in a default or normal mode of operation when an operator is not looking at the display device, then automatically change to a glare mitigation mode when an operator looks at the screen.

An example apparatus can include a microprocessor-based display controller configured with at least a mode determination unit (MDU) and a memory. Using data from one or more sensors, such as an inward-facing camera, the MDU can designate an operational mode for a display device. An operational mode can be associated with one or more display parameters or characteristics that can effect interface screen visibility. For example, a glare mitigation mode can be associated with a particular brightness value and/or contrast ratio that improves screen visibility under glare conditions. Color palettes and other display characteristics may also vary among the different operational modes. Predetermined values or ranges for the display characteristics associated with various modes can be stored in the memory and selected when an operational mode is designated.

An example method of practicing the invention can include receiving data from a sensor and automatically executing an operational mode at a display device by implementing particular display parameters. For example, a method can include using data from a camera to determine whether low-light conditions are present in the display environment. A method can further include using data or images recorded by the camera to determine whether an operator is looking at the display screen, for example a method can include tracking an operator's gaze. A method can include implementing a resource conservation mode in which the amount of data provided to the display is reduced, and the display characteristics such as brightness are toned down when the operator is not looking at the screen. When the operator is looking at the machine, a method can include implementing an enhanced visibility mode in which display characteristics are tailored for improving visibility in dark environments.

In an example embodiment, a method can include determining whether glare conditions are present at a display. By way of example, a method can include calculating the incident angle of sunlight at the display and using it to determine whether the orientation of the display with respect to the sun is one conducive to producing glare at the display. If so, a method can include implementing a glare mitigation mode, otherwise a default or other non-glare-mitigation mode can be implemented. In an exemplary method, a glare mitigation mode is implemented only when an operator's gaze is directed toward the display screen. In example embodiment, under no-glare daytime conditions, a method can include providing a sleep or conservation mode when an operator is not looking at the screen and a “normal” or “full-scale” display mode when an operator is looking at the screen. A variety of modes can be defined by display characteristics and implemented under predetermined conditions.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 shows an example operating environment of the invention;

FIG. 2 shows an example system for improving display visibility;

FIG. 3 shows an example operating environment;

FIG. 4 shows an example method;

FIG. 5A shows an example method of practicing the invention;

FIG. 5B shows an example method of practicing the invention;

FIG. 5C shows an example solar geometry model;

FIG. 5D shows an example method of practicing the invention; and

FIG. 6 shows an example method of practicing the invention.

The drawing figures do not limit the present invention to the specific embodiments disclosed and described herein. The drawings are not necessarily to scale, emphasis instead being placed upon clearly illustrating the principles of the preferred embodiment. Corresponding reference characters indicate corresponding parts throughout the views of the drawings.

### DETAILED DESCRIPTION OF EXAMPLE EMBODIMENTS

As required, example embodiments of the present invention are disclosed. The various embodiments are meant to be non-limiting examples of various ways of implementing the invention, and it is understood that the invention may be embodied in alternative forms. The present invention will be described more fully hereinafter with reference to the accompanying drawings in which like numerals represent like elements throughout the several figures, and in which example embodiments are shown. The figures are not necessarily drawn to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the exemplary embodiments are discussed in the context of an agricultural vehicle, it will be understood that the present invention need not be limited to that particular arrangement. Furthermore, control functions described as performed by a single module, can in some instances, be distributed among a plurality of modules. In addition, methods having actions described in a particular sequence may be performed in an alternate sequence without departing from the scope of the appended claims.

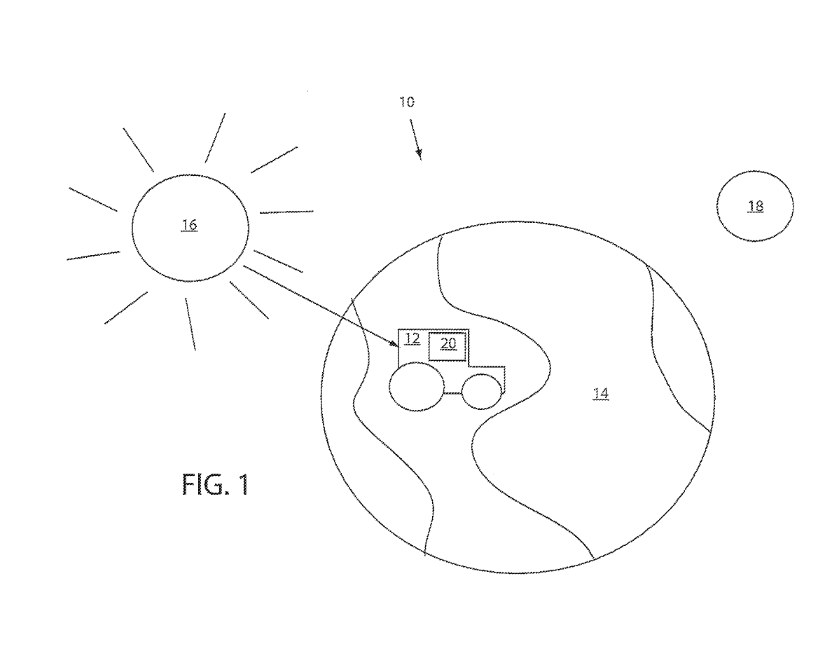

Referring now to the Drawings in which like numerals refer to like elements throughout the several views, FIG. 1 shows an operating environment 10 in which an agricultural vehicle 12 is positioned on the earth 14. As indicated by the depiction of the sun 16 and the moon 18, the agricultural vehicle 12 may be tasked to perform a work assignment during daytime as well as nighttime hours. Factors related to the time of day and the vehicle 12 location on earth can affect display screen visibility in various ways. However, the vehicle 12 is equipped with a visibility improvement system (VIS) 20 which can improve display visibility by offering various operational modes for a display device. The various modes can be associated with display parameters tailored to provide a desired effect, such as improved visibility during daytime hours or during nighttime hours. In an example embodiment, the VIS 20 can automatically alter operational modes or display parameters to dynamically respond to events or changes in conditions at the vehicle 12. The VIS 20 can improve screen visibility for the operator while saving the operator from having to manually tweak display characteristics.

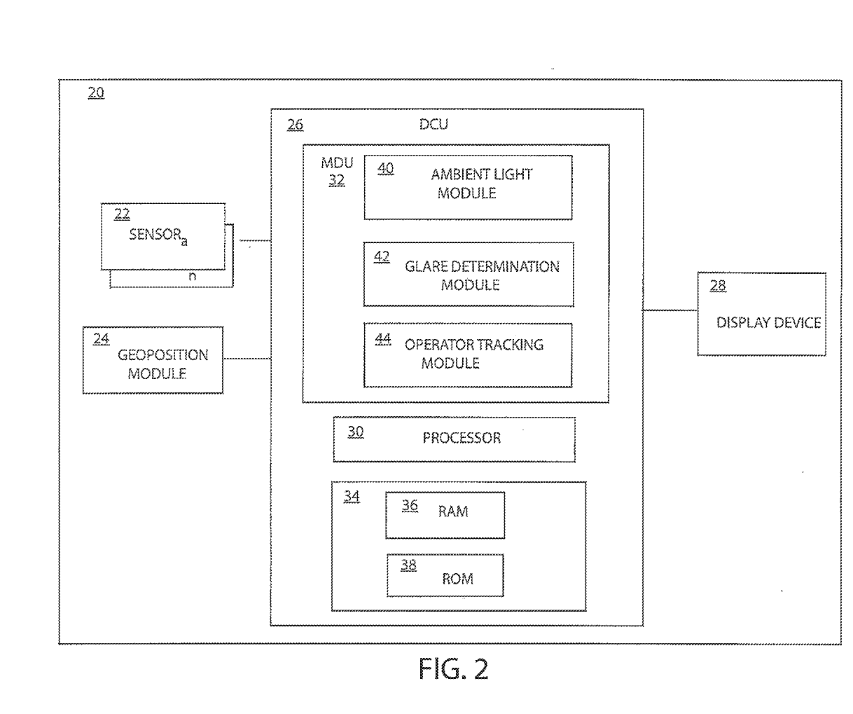

FIG. 2 shows a block diagram of an example embodiment of the VIS 20, which can include one or more sensors 22, a geopositioning module 24, a display control unit (DCU) 26 and a display device 28. The sensors 22 can be configured to provide data to the display controller 24. In an example embodiment, the VIS 20 can include a light detecting sensor such as a camera, configured to detect ambient light levels within a vehicle cabin and record images that can be used to track operator motion. The geopositioning module 24 can be configured to provide current location and heading information for the vehicle 12. For example, the geopositioning module can include a satellite antenna and receiver configured to communicate with a satellite navigation system such as the Global Positioning System (GPS) or the Global Navigation Satellite System (GNSS), to receive latitude and longitude coordinates, and may also include sensors disposed at the vehicle, such as a compass or tracking device configured to provide bearing information.

The DCU26 can comprise a microprocessor-based device configured to control operation of the display device 28. In an example embodiment, the DCU 26 can comprise hardware, software and firmware and be configured to designate and implement an operational mode for the display device 28. By way of example, the DCU26 can be configured to determine an operational mode, and provide the control signals to the display device 28 to implement the operational mode. In an example embodiment, the DCU 26 can be configured to designate a display characteristic or feature, such as, but not limited to, brightness level, contrast ratio, color palette, and the like, and provide the control signals necessary to effect that characteristic on a user interface screen provided by the display device 28.

In an example embodiment, the DCU 26 can comprise a microprocessor 30, a mode determination unit (MDU) 32 and a memory 34. The microprocessor 30 can be a special purpose processor dedicated for implementing methods of the invention, or a general purpose processor configured to perform various functions related to display device 28 operation. As discussed herein, the microprocessor 30 can be configured to provide the appropriate signals to the display device 28 to implement a user interface screen under various operational modes. However, it is contemplated that an embodiment of the invention can include the microprocessor 30 coordinating with a separate device to effect the various modes and implement display characteristics designated by the display controller 26. For example, the display controller 26 can be configured to communicate and/or coordinate with a computing device (not shown) coupled to the display device 28, which can be configured to receive data from various onboard sensors at the vehicle 12 and provide the information to an operator through a user interface screen.

By way of example, but not limitation, the MDU 32 can comprise software executable by the microprocessor 30 to implement various algorithms and routines that can be used in the determination of an operational mode. In an example embodiment, the MDU 32 can designate an operational mode, and the microprocessor 30 can be configured to retrieve a display parameter associated with that mode from the memory 34. For example, the memory 34 can include random access memory (RAM) 36 used by the microcontroller 26 to perform the processing operations required to execute the MDU 32, and can also include read-only memory (ROM) 38 which can be used to store predetermined parameters and display characteristics associated with the various modes of operation.

The example MDU 32 includes an ambient light module (ALM) 40, a glare determination module (GDM) 42, and an operator tracking module (OTM) 44. The ALM 40 can be configured to receive input from an ambient light sensor, such as a camera or other light detection device, pertaining to the level of light intensity in the display device 28 environment, for example the vehicle 12 operator cabin. The ALM 40 can be configured to compare the light level to a predetermined low-light range stored at the ROM 38 to determine whether a display device is in a low-light environment or not.

The GDM 42 can be configured to determine whether screen visibility is likely to be impaired by glare. i.e., whether factors that contribute to producing glare at the display screen are in effect. The visual disability caused by glare is a physiological effect that consists of a reduction in visibility caused by light scattered in the eye. Glare is caused by a difference in luminous intensity, and can cause eye strain, discomfort, and fatigue in addition to impaired vision. There are different types of glare that can be associated with display screens, for example the glare caused by the luminosity of the display screen itself, and veiling glare, generally caused by the reflection of sunlight off the display screen. Display settings can effect the amount of glare experienced by a display user, for example black backgrounds can show more glare than white backgrounds. Thus, display characteristics can be altered to increase visibility under glare conditions.

A primary factor contributing to veiling glare is the orientation of the sun with respect to the display, as that orientation determines the incident and reflection angles of sunlight as it impinges a display surface. FIG. 3 shows an operator 45 seated in a cabin 48 of the agricultural vehicle 12 in which the display device 28 is disposed. In an example embodiment, the GDM 42 can be configured to determine the angle θ_{id}, defined as the angle between a ray of incident light and a display device 28 surface normal N, and use it as a metric for determining whether a glare condition exists. For example, experimental tests with human subjects can be performed to determine the values of θ_{id}, that result in impaired visibility. These angles can be identified as glare angles and can be stored in the ROM 38. The example GDM 42 can be configured to determine θ_{id}, in real time, and compare it to the predetermined glare angles to determine whether a glare condition is in effect. In an alternative embodiment, glare can be defined as a mathematical expression that includes θ_{id}, and/or other variables based on the orientation of the sun relative to a display screen, and the GDM 42 can be configured to perform the calculations defined by the mathematical expression to determine whether a glare condition is present.

The OTM 44 can be configured to receive information from one of the sensors 22, such as images recorded by one or more cameras, and use it to track an operator's gaze. Various methods can be used to track an operator's gaze. For an example, refer to “Automated Classification of Gaze Direction Using Spectral Regression and Support Vector Machine” by Steven Cadavid et al., Department of Electrical and Computer Engineering, University of Miami, IEEE 978-1-4244-4799-2/09; and “Real-time Tracking of Face Features and Gaze Direction Determination” by George Stockman et al., Applications of Computer Vision, 1998. WACV '98 Proceedings, Fourth IEEE Workshop, October 1998, pages 256-257; which are also incorporated herein in their entireties by reference. The OTM 44 can be configured to use the direction of an operator's gaze, and the display device location and orientation in a vehicle cab to determine whether a display device is in an operator's line of sight. It is further contemplated that in an alternative embodiment, a separate sensor device in the form of a tracking device can be configured to provide operator gaze direction to the OTM 44 which can be configured to determine whether the display device 28 is in the operator line of sight.

As mentioned previously herein, the display device 28 can be configured for coupling with a computing apparatus (not shown) at the vehicle 12. The display device 28 can be configured to display information received from the computing apparatus in a user interface screen that can provide a variety navigable windows and soft buttons for user input. The display device 28 can comprise a display surface that can be illuminated by any of a variety means. For example, the display device 28 can comprise a liquid crystal display, LED display, OLED display, plasma display, etc. that can respond to voltage signals from a controller such as the DCU 26 or the aforementioned computing device. In an example embodiment, the display device 28 can be mounted in a fixed position in the cabin of the vehicle 12, such as on an armrest or console. In an example system, the location and orientation of the display screen can be provided to the DCU 26 and stored at the memory 38. The display device 28 may also include an electronic compass so that the orientation of the display device 28 can be computed and determined relative to the direction that the vehicle 12 is facing.

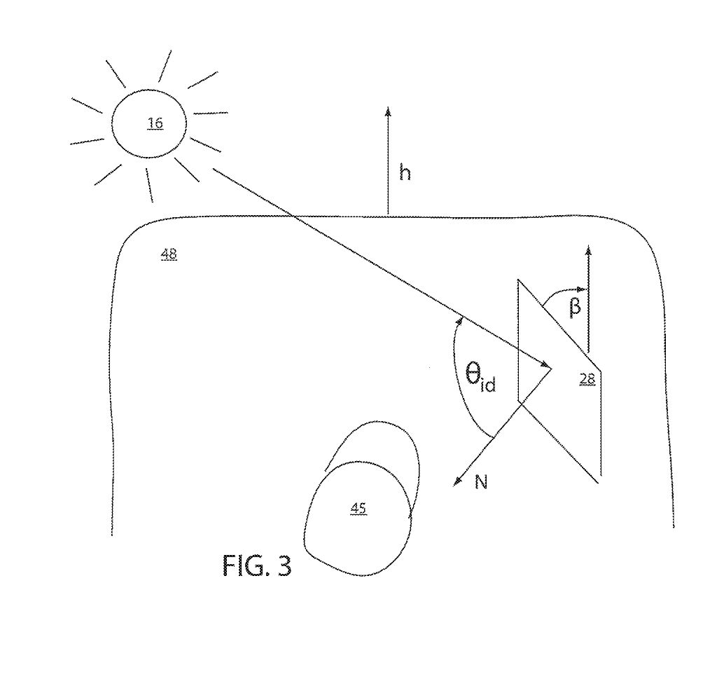

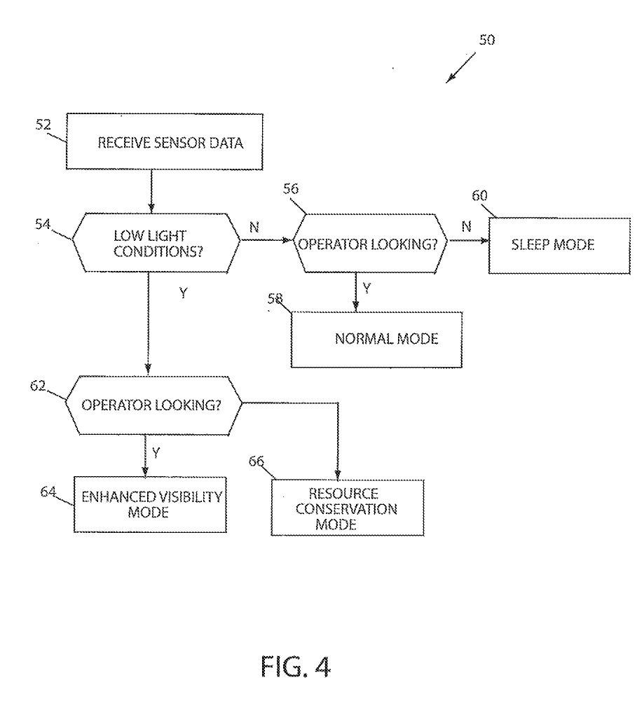

A system of the invention can automatically adjust display parameters to improve visibility for a variety of ambient conditions, reducing operator eye strain and improving operator performance without requiring additional action from the operator. In addition, methods of the invention can conserve power and processing resources. FIG. 4 shows an example method 50 of practicing the invention. At block 52, sensor data can be received. For example, the DCU 26 can receive data from an ambient light sensor 22a. It is contemplated that the DCU 26 can be coupled to the sensor 22a by a communications bus, or can be communicatively coupled to a computing device configured to provide sensor 22a data. At decision block 54 a determination can be made as to whether a display device is in a low light environment. For example, the LDM 40 can compare light intensity information from the sensor 22a to a predetermined range of values stored at the memory 38. In an example embodiment, a low-light condition is satisfied when the light intensity falls within a predetermined “low-light” range, for example, in the range of intensities typically experienced during evening and nighttime periods when the vehicle 12 interior is dark enough that screen visibility is decreased. If a determination is made that low light conditions are satisfied, the method can continue to block 62. Otherwise, the method can include implementing a “non-low-light” mode. An example method can include implementation of more than one “non-low-light” modes. By way of example, but not limitation, selection of a particular “non-low-light” mode can depend on a determination at decision block 56 as to whether an operator is looking at the display screen, in which a “normal” mode can be implemented at block 58, or not looking, in which case a sleep mode or default mode can be designated at block 60. Various modes can be defined by predetermined values of various display characteristics, and implemented by designating a parameter that corresponds to the operational mode selected, and sending the appropriate control signal to the display device 28 to effect the parameter.

As stated above, under a low-light condition, the method 50 can continue to decision block 62 where a determination can be made as to whether an operator is looking at the display. For example, images from a camera received at block 52 can be used by the operator tracking module 44 to determine the direction of an operator's gaze. The OTM 44 can use the location and orientation of the display screen of the display device 28 stored in the memory 38 to determine whether it is in the operator's line of sight. Alternatively, the OTM 44 can receive gaze direction at block 52 and determine if display device 28 is in the operator line-of-sight. If the operator is looking at the display, then an enhanced visibility mode can be implemented at block 64. The enhanced visibility mode can be characterized by display parameters such as, but not limited to, brightness and contrast ratios that can improve visibility in an darkened environment. If the operator is not looking at the display, a resource conservation mode can be implemented at block 68 which can reduce display brightness and data refresh rates to reduce eye strain and distraction in a darkened cabin. Thus, method 50 can be practiced to implement an operational mode with improved visibility under low-light conditions, as well as implement a resource conservation mode for low-light conditions.

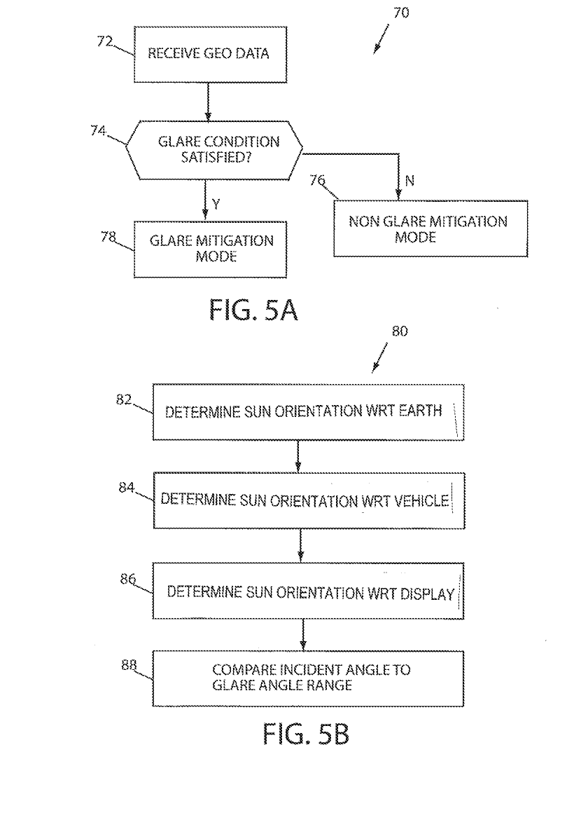

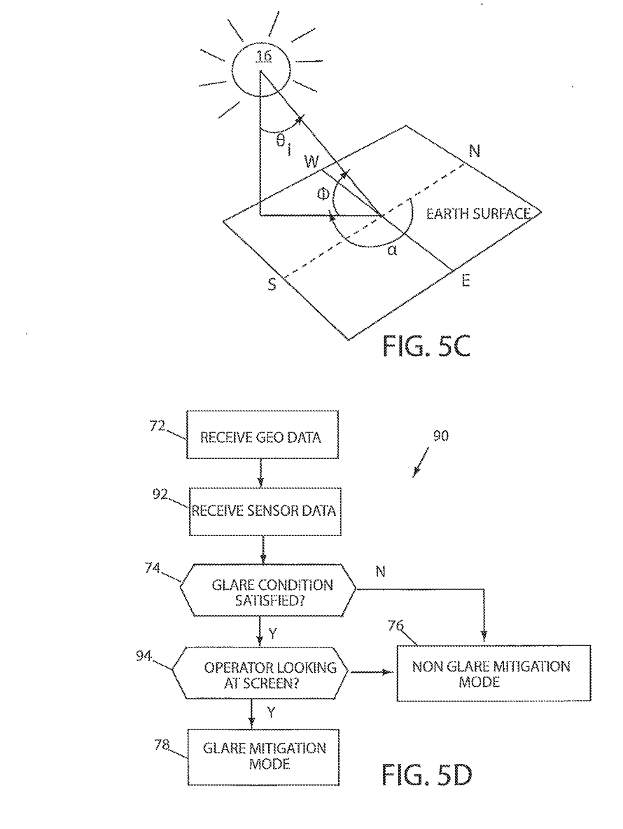

FIG. 5A depicts a flow diagram for a method 70 that can be practiced to improve visibility during daylight hours in which a display screen can be susceptible to glare. At block 72, geoposition and time data can be received. For example, the MDU 32 can receive latitude and longitude data from the geoposition module 24. Local time and date can be monitored at the DCU 26 or received from the geoposition module 24. At block 74 a determination can be made as to whether a glare condition is satisfied. FIG. 5B shows an example method 80 of making this determination. By way of example, a glare condition can be defined in terms of the incident angle of sunlight. Accordingly, method 80 can be practiced to make this determination. At block 82, the orientation of the sun with the earth can be determined. For example, the GDM 42 can be configured to use geoposition and time data to determine the solar position for the vehicle's current location. FIG. 5C shows a solar geometry diagram indicating θᵢₑ, incident angle of sun with respect to the earth, φ, the solar altitude or elevation, and α, the solar azimuth, which can be used to define a solar position. The GDM 42 can be configured to execute an algorithm to make this determination, or can be configured to receive this information from the internet over a communications network, such as a cellular network, in which the vehicle 12 is configured to communicate. For example, the National Oceanic and Atmospheric Administration (NOAA) provides a website with a solar calculator: http://www.esrl.noaa.gov/gmd/grad/solcalc/ which can provide solar azimuth, elevation and declination angles for a location on earth. Similarly, the University of Oregon Solar Radiation Monitoring Laboratory provides a solar position calculator at: http://solardat.uoregon.edu/SolarPositionCalculator.html. If not linked to these websites, the GDM 42 can be configured to execute a similar algorithm to calculate the solar position with respect to the earth.

The method 80 can continue at block 84 in which the solar position with respect to the vehicle can be calculated. As the vehicle 12 traverses its assigned field, light may cause glare in a first direction, but not pose a problem when an operator turns and heads in an opposing direction. Heading or bearing information received from the geoposition module 24 or calculated at the DCU 26 can be used along with the solar position calculated at block 82 to calculate how the sunlight is incident at the vehicle 12. At block 86 the incident angle of the sunlight with respect to the display, θ_{id}, can be calculated knowing the orientation of the display device 28 and θᵢₑ. FIG. 5C shows the geometry involved in making this determination, including the direction h in which the vehicle 12 is headed, and the angle β between the display 28 and a linear axis of the vehicle 12. At block 88, θ_{id} can be compared to a predetermined range of incident angles known to produce glare that can impair an operator's ability to read a display screen, i.e. “glare angles” stored at the memory 38. If a determination can be made as to whether θ_{id} falls within a predetermined range of incident angles known to produce glare that can impair an operator's ability to read a display screen. If so, a glare condition exists, if not, then a glare condition does not exist.

Referring back to FIG. 5A, if a glare condition is satisfied, the method 70 can continue at block 78 at which a glare mitigation mode can be implemented by selecting and implementing display parameters and attributes that make a screen more visible when glare is present. If a glare condition is not satisfied, the method 70 can continue to block 76 where a “non glare-mitigation” mode can be designated and implemented. For example a “normal” operating mode, a “sleep mode” or other type of operational mode can be implemented. FIG. 5B shows a method 90 that is similar to the method 80, but includes operator gaze as a factor that determines operational mode. A block 92 is included at which sensor data can be received. For example, operator images can be received from a camera, or gaze direction can be received from a tracking device at the DCU 26. In addition, following decision block 74, a decision block 94 can be included at which a determination can be made as to whether an operator is looking at the display device 28. As discussed in greater detail above, the OTM 44 can make this determination. If the operator is looking, a glare mitigation mode is implemented at block 78; if the operator is not looking, a non glare-mitigation mode is implemented at block 76.

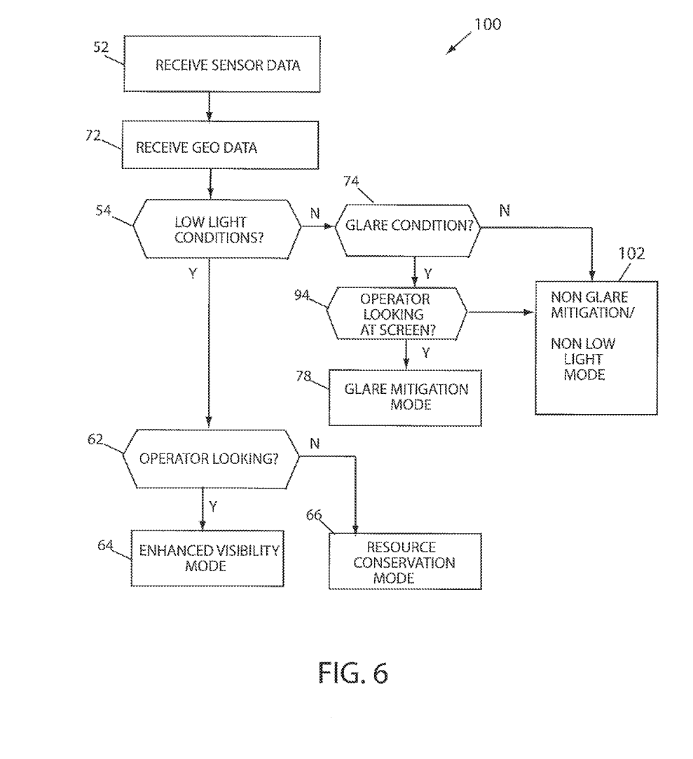

FIG. 6 shows an example method 100 that combines blocks of the methods discussed above. Blocks that have been discussed above will not be described again here. However, the method 100 includes a block 102 at which an operational mode that is not a glare mitigation mode, nor a low-light mode can be implemented, such as, but not limited to the “normal mode” of block 58 or the sleep mode of block 60. The example method 100 shows that a method of the invention can include both glare mitigation as well as night-time vision enhancement. It is also noted that a non glare mitigation mode and a non-low light mode can each comprise the same “normal” or default mode. It can also be seen from the various example methods that actions may be performed in various sequences.

The invention provides a system and method for improving visibility under various environmental conditions by offering different operational modes characterized by different display parameters, characteristics, and attributes, such as, but not limited to, display brightness, contrast ratios, and color palettes. In an exemplary embodiment, operational modes are dependent on whether an operator is looking at the display screen. When an operator is not looking at the screen there is no need to compensate for environmental conditions such as glare or darkness. In those circumstances it may be more prudent to conserve resources and avoid distracting an operator. Resource conservation modes can be practiced in the daytime as well as the nighttime when an operator is not gazing at the screen. The automatic dynamic response of a system to changes in environmental conditions or operator gaze direction is a beneficial feature which can assist the operator in performing his task, as well as mitigate operator fatigue by decreasing eye strain. Nevertheless, in an example embodiment, a method can include receiving user input related to operational mode, such as override input, or manually selecting a preferred mode. It is further contemplated that the invention can be practiced at a vehicle having a movable display. In such a case, one or more cameras, along with image processing software can be used to determine the direction that display is facing, or a sensor can be used to provide that information to the MCU 26 to facilitate calculation of the angle θ_{id}.

As required, illustrative embodiments have been disclosed herein, however the invention is not limited to the described embodiments. As will be appreciated by those skilled in the art, aspects of the invention can be variously embodied, for example, modules described herein can be combined, rearranged and variously configured, and may include hardware, software, firmware and various combinations thereof. Methods are not limited to the particular sequence described herein and may add, delete or combine various steps or operations. The invention encompasses all systems, apparatus and methods within the scope of the appended claims.

1.-8. (canceled)

9. A system configured to improve user interface visibility, comprising:
a display device configured to provide a user interface screen;
a geoposition module configured to provide current geographical location of said display device;
a glare determination module (GDM) configured to calculate solar position with respect to said device to determine whether a glare condition exists; and
a processor configured to effect an operational mode for said display device.

10. The system of claim 9, configured to determine that said glare condition exists when a calculated incident angle lies within a predetermined range.

11. The system of claim 9, wherein said operational mode is associated with one or more predetermined parameters for said display device.

12. The system of claim 9, configured to implement a glare mitigation mode by effecting a parameter for said display device that improves visibility when under glare.

13. The system of claim 12, configured to effect said glare mitigation mode only when an operator's gaze is directed at said display device.

14. The system of claim 9, configured to automatically change said operational mode by adjusting a parameter for said display device.

15.-19. (canceled)
